(19) United States
(12) Patent Application Publication
(10) Pub. No.: US 2026/0239459 A1
(43) Pub. Date: Aug. 13, 2026

(54) DYNAMIC ADAPTABLE CONNECTIVITY FOR USER EQUIPMENT

(71) Applicant: Charter Communications Operating, LLC, St. Louis, MO (US)

(72) Inventor: Saran Khalid, Denver, CO (US)

(73) Assignee: Charter Communications Operating, LLC, St. Louis, MO (US)

(21) Appl. No.: 19/049,368

(22) Filed: Feb. 10, 2025

(51) Int. Cl. H04W 76/14; H04W 8/22; H04W 24/02

(52) U.S. Cl. CPC H04W 76/14; H04W 8/22; H04W 24/02

(57) ABSTRACT

A cellular network supports end-to-end communications with a chain of user equipments (UEs) (e.g., cell phones and other suitable wireless devices) having (i) a direct UE having a direct connection with the cellular network and (ii) one or more indirect UEs having no direct connection with the cellular network, but a device-to-device (D2D) connection with at least one other UE in the chain.

### BACKGROUND

### Field of the Disclosure

The present disclosure relates to wireless communications and, more specifically but not exclusively, to wireless communications for user equipment that supports cellular communications and device-to-device (D2D) communications.

### Description of the Related Art

This section introduces aspects that may help facilitate a better understanding of the disclosure. Accordingly, the statements of this section are to be read in this light and are not to be understood as admissions about what is prior art or what is not prior art.

Cellular subscribers can end up in situations when there is no direct coverage available for their wireless user equipment (UE), such as their cell phone.

### SUMMARY

When there is no direct coverage available for a cellular subscriber's cell phone or other wireless UE, it is possible that, in that vicinity, one or more other UEs might have connectivity that can be leveraged to allow connectivity for the UE with no service. This would be useful for cases when emergency messaging is needed, e.g., for safety, 911, urgent communication with friends and family, etc. This communication might not be limited to just emergency messaging but could allow other forms of services as well depending on the quality of the end-to-end link. Some services may be subjected to the network provider's policy.

This disclosure provides a mechanism to establish a dynamically adapting channel consisting of various smaller local channels (e.g., D2D connections) that allow end-to-end communication between a cellular network and UEs that do not currently have direct connections available to the cellular network.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a schematic diagram of a situation in which a UE in vehicle is able to communicate directly with a cellular network, but the UEs in the other vehicles are currently not able to communicate directly with the wireless network, according to certain embodiments of the present disclosure;

FIGS. 2A-2B represent the steps of an example process of the present disclosure; and

FIG. 3 is a simplified hardware block diagram of an example node that can be used to implement any of the nodes of FIG. 1, including the cellular network.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

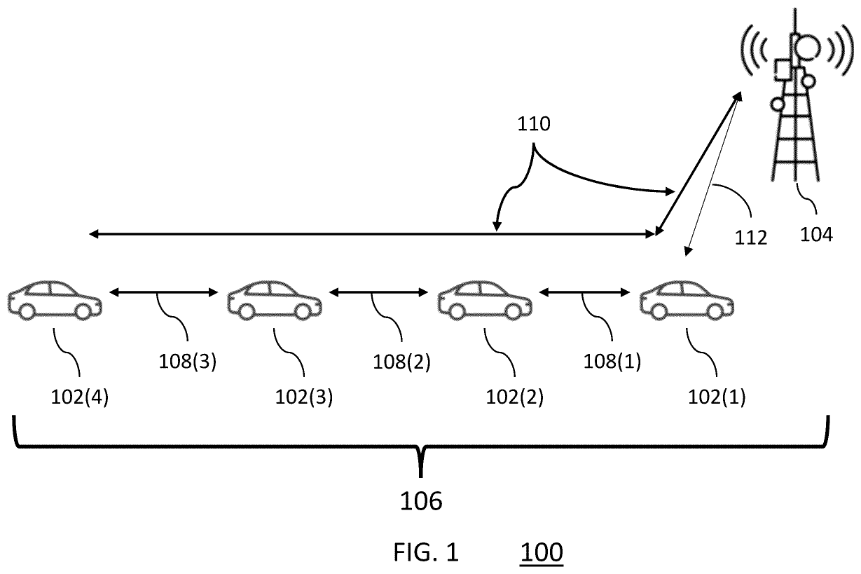

FIG. 1 is a schematic diagram of a situation 100 in which a UE (not explicitly shown in FIG. 1) in vehicle 102(1) is able to communicate directly with a cellular network 104, but the UEs in the other vehicles 102(2)-102(4) are currently not able to communicate directly with the wireless network 104. Note that the UEs in vehicles 102(1)-102(4) may be, for example, cell phones of the drivers and/or passengers in vehicles 102(1)-102(4) and/or the UEs may be built into the vehicles 102(1)-102(4) themselves. For simplification purposes, each vehicle 102(i) will be assumed to be associated with a single UE, which will be referred to as UE 102(i). Those skilled in the art will understand how to implement the disclosed technology for situations in which a vehicle may have more than one UE associated with it.

In the situation 100 of FIG. 1, the UEs 102 mobiles can form a chain 106 of links to convey important information based on priority, e.g., emergency, important texts, etc. The UEs 102 will enable D2D communication with each other and eventually reach the UE 102(1) with direct cellular service. These D2D links 108 form a cascade of channels that will form one communication channel 110 end to end. The communication is based on radio factors such as noise, power, link quality, available bandwidth, etc. Because of various factors such as distance and noise between various UEs 102, the overall communication supported will depend on the weakest D2D link 108 and the health of the overall communication channel 110.

The data session requested could come from any UE 102 in the chain 106, both in uplink and downlink. Before any communication can start, the UEs 102 must communicate and connect with each other. This communication and connectivity will be based on D2D communication. The UEs 102 will form this chain 106 of communication until eventually a UE 102 is reached with direct connectivity to the cellular network 104. Once the chain 106 is established, the data could come from various UEs 102 within the chain. This can result in congestion, which requires traffic management. This traffic management may be based on priority, e.g., important messages first and then low priority. The characteristics of weakest D2D link 108 in the chain 106 will determine how much traffic could be passed and control the quality of the channel 110. In some embodiments, the cellular network 104 controls the chains. In other embodiments, the UEs 102 take over and decide the communication through their chain.

In order to establish connectivity towards the cellular network 104, a UE 102 with no service requests a D2D link 108 for communication, which is accepted by the next UE 102, which in turn establishes a D2D link 108 with the following UE 102 until a UE 102 with direct connectivity with the cellular network 104 is established. This communication might not be in order for the overall channel 110 to get formed; multiple makes and breaks may be needed and these can happen at different times. UEs will discover a UE that has connectivity with the network. This process will continue until a UE with no connectivity finds a UE with connectivity. It will form loose connections with multiple UEs until a UE tells that it has connectivity. In that case, the loose connection is turned into a solid connection, i.e., ready for data exchange by meeting D2D requirements. The UE 102(1) with direct network connectivity provides data for all the UEs 102 that are trying to connect, e.g., C-RNTI, IMSI, GUTI, etc. End-to-end data sessions for various UEs are distinguished based on this information. For each request of data transfer, the cellular network 104 would ask for data transfer capabilities from the UEs 102 and also determine the number of hops. The cellular network 104 will then request health of each D2D link 108 to determine the capabilities of the overall chain 106. This is based on the data collected by UEs as they try to form connections with other UEs. Since there are multiple hops and a different number of hops for each UE 102 in the chain, a matrix may be calculated that provides health of each D2D link 108. The weakest link 108 between a UE 102 and the cellular network 104 will decide how much data could be supported for each link. The network will determine which would be the best path/chain for a given UE and then instruct the UEs to form that chain by passing the information down to UEs. Based on the cellular network 104's capacity, UE 102 capabilities, and the health of the communication channel 110, the cellular network 104 will notify the UEs 102 what features could be used, e.g., emergency messages, texts, and/or data transfer.

During a discovery phase, the UEs 102 will talk to various other UEs 102 in an attempt to find what other possibilities exist, e.g., by sending beacon/discovery messages to determine how they can ultimately connect to the cellular network 104. The networking possibilities are based on various criteria, e.g., quality of the chain 106. The UEs 102 will make and break until a good chain 106 has been found. These makes and breaks are happening as a result of UEs being mobile. This process can be managed by the UEs 102 or the cellular network 104's infrastructure or coordinated by both the UEs 102 and the cellular network 104. The infrastructure can assist in finding the best network chains 106 for a given UE 102. In addition, the network policy will define how many concurrent D2D links 108 a UE 102 is allowed to support for network conditions, UE performance and capabilities, etc.

It is very much possible that UEs 102 will go out of the area or not be suitable for communication due to the dynamic nature of mobile communications. This is applicable to other mobiles as well; i.e., for an established chain, any mobile can leave the chain. In that case, the UEs 102 may constantly be transmitting signals to ensure that they can find a suitable replacement. All mobiles will constantly be sharing signaling messages to ensure they are present and share the link information they are experiencing. This will help the network in determining if a different chain could be established or a previously found chain which was passed on because a better chain was available. This can be dynamic, e.g., by sending signals or by using the old data and starting with the next best option available. If an intermediate UE 102 leaves the chain 106, then the now-disconnected UEs 102 will need to find a replacement chain 106 to achieve indirect network connection, which may involve the previous UEs 102 and/or different UEs 102. This could be based on the previous data and starting with the next best option or restarting the beacon messaging again as controlled by the network.

UEs 102 knowing the capabilities at the hops will either not allow services that the chain 106 cannot support or will buffer services that are not presently allowed. The network policy will decide the number of hops and services offered over the established chain 106. The UEs 102 may be instructed to buffer some not-so-important/low priority data until the cellular network 104 tells the UEs 102 to share the data. The network, based on the link's quality, load on the network, changing nature of the link, etc., will decide what capabilities are supported.

In order to communicate with the different UEs 102 in a chain 106, the cellular network 104 needs some or all of the following information about each UE: International Mobile Subscriber Identity (IMSI), Global Unique Temporary Identifier (GUTI), and Cell Radio Network Temporary Identifier (C-RNTI). A different session ID is assigned to each different UE 102 in the chain 106, and sequence numbers are applied to the different packets within each session. This is needed to identify a cell phone, data session, and packets for the exact application, etc.

For the present disclosure, UE 102(1) is referred to as a “direct” UE because it has a direct cellular connection 112 to the cellular network 104, while UEs 102(2)-102(4) are referred to as “indirect” UEs because they do not have a direct cellular connection to the cellular network 104.

Referring again to FIG. 1, although indirect UEs 102(2)-102(4) are not currently able to communicate directly with the cellular network 104, they are able to communicate via device-to-device (D2D) communications with other UEs 102. In particular, UE 102(2) is able to establish D2D link 108(1) with direct UE 102(1), which also has cellular link 112 with cellular network 104; UE 102(3) is able to establish D2D link 108(2) with UE 102(2); and UE 102(4) is able to establish D2D link 108(3) with UE 102(3).

D2D communication stands for device-to-device communication. D2D communication was first introduced by 3GPP in 4G allowing UEs to communicate with each other directly in the absence of a telecommunication provider's service or if only some devices in the group of devices have service. D2D communication uses the same technology as, e.g., LTE or NR for direct communication. The underlying technology and basics are the same, i.e., use of resources blocks, channels, etc.

With cellular link 112 and D2D links 108(1)-108(3) in place, the cellular network 104 is able to communicate with each of the UEs 102(1)-102(4). In particular, the cellular network 104 is able to communicate directly with direct UE 102(1) via cellular link 112; indirectly with indirect UE 102(2) via cellular link 112, UE 102(1), and D2D link 108(1); indirectly with indirect UE 102(3) via cellular link 112, UEs 102(1) and 102(2), and D2D links 108(1) and 108(2); and indirectly with indirect UE 102(4) via cellular link 112, UEs 102(1)-102(3), and D2D links 108(1)-108(3).

The chain 106 of links consisting of cellular link 112 and D2D links 108(1)-108(3) may be said for form a single, end-to-end communication channel 110 between cellular network 104 and indirect UE 102(4). In some implementations, that same communication channel 110 is shared for communications between cellular network 104 and each other indirect UE 102(1)-102(3). In other implementations, each UE 102 will have its own dedicated communication channel with the cellular network 104. In still other implementations, direct UE 102(1) will have its own direct communication channel with cellular network 104, while the three other indirect UEs 102(2)-102(4) will share a different, indirect communication channel with cellular network 104. The following description assumes that all four UEs 102(1)-102(4) will share the same communication channel 110. This is dependent on the implementation of the technology to establish end-to-end data channels with individual UEs or encapsulate the data within already established data channels. Data segregation and aggregation will be performed at various points in the chain.

The types of communication enabled by this chain 106 of links depend on such radio factors as noise, power, and quality of the link communications. In particular, for a given chain 106 of D2D links 108, the overall communication supported will typically depend on the poorest link in the chain, which in turn will also decide what capabilities are supported. If the link deteriorates, then the network can switch from the existing chain to a different chain.

In order to establish communication channel 110, each UE 102 must establish one or two connections with its one or two neighbors. In particular, UE 102(1) establishes cellular link 112 with cellular network 104 using conventional cellular technology. In addition, each UE 102 is capable of transmitting outgoing D2D beacons and responding to incoming D2D beacons using conventional D2D technology to establish D2D links 108 with one or more nearby UEs 102. D2D technology was first introduced in release 12 of 3GPP. 3GPP is constantly working on the evolution for 5G. Concurrent links with other mobiles are possible as resource blocks and could simultaneously be allocated. However, concurrent links need to be coordinated because UEs are going to need a time sync from a central source (network) or another mobile with connectivity to the network for proper allocation of resources. For the purpose of the present disclosure, only loose connections are formed, e.g., by reading measurements and getting status if a UE is connected to a network.

Those skilled in the art will understand that, in general, a given UE 102(i) may be within range of establishing concurrent D2D links with up to a specified number of other UEs, with the specified number depending in part on the capabilities of the UE 102(i). This range will be defined by the network, e.g., based on the type of terrain, such as city vs. mountains or suburban vs. urban. Deciding factors could be distance, number of UEs in a given area, type of mobile traffic, e.g., slow moving vs. fast moving. For example, in hilly terrain where the number of UEs is small and mobiles are spread apart by significant distances, the distance limit will be higher. On the other hand, the distance limit would be much smaller in urban areas due to the fact that there are a large number of mobiles not too far apart from each other and long chains are likely not required.

In one possible implementation, each indirect UE 102 that does not have a direct cellular connection will broadcast D2D beacons in an attempt at establishing D2D links with one or more other UEs 102 to eventually form a communication channel with the cellular network 104 via a UE 102 that does have a direct cellular link with the cellular network 104, such as direct UE 102(1) having direct cellular link 112.

Thus, in the situation 100 depicted in FIG. 1, each of indirect UEs 102(2)-102(4) will broadcast D2D beacons and the nearby UEs 102, including direct UE 102(1), will respond to establish D2D links 108(1)-108(4). When an indirect UE 102(i) establishes D2D links 108 with two different UEs 102, the UE 102(i) bridges those two D2D links 108 to form a tentative communication channel. If an indirect UE 102(i) has more than two D2D links 108 with more than two different UEs 102, the UE 102(i) bridges each different pair of D2D links 108 to form multiple, tentative communication channels. For example, if an indirect UE 102(i) establishes three D2D links 108 with three other UEs 102, then the UE 102(i) can form up to three different, tentative communication channels, corresponding to the three different pairs of the three D2D links. If an indirect UE 102(i) establishes four D2D links 108 with four other UEs 102, then the UE 102(i) forms up to six different, tentative communication channels, corresponding to the six different pairs of the four D2D links. And so on.

Over time, as more and more indirect UEs 102 bridge their different pairs of D2D links 108 together, the indirect UE 102(i) will become part of tentative communication channels corresponding to different sets of indirect UEs 102. For example, in the situation 100 of FIG. 1, at some point in time, indirect UEs 102(2)-102(4) will form a tentative communication channel consisting of D2D links 108(2) and 108(3).

At some later point in time, one of the tentative communication channels of indirect UE 102(i) may reach a direct UE 102. For example, in the situation 100 of FIG. 1, at some later point in time, the tentative communication channel consisting of D2D links 108(2) and 108(3) will reach direct UE 102(1) via D2D link 108(1). At that point in time, direct UE 102(1) will inform indirect UE 102(2) that UE 102(1) is a direct UE, indirect UE 102(2) will bridge D2D link 108(2) and D2D link 108(1), and direct UE 102(1) will bridge D2D link 108(1) and cellular link 112 to form communication channel 110. The cellular network 104 will (i) learn of the existence of indirect UEs 102(2)-102(4) and the characteristics (e.g., signal strength, signal quality (SNR), link latency, UE capabilities, network policy, speed of the mobile, etc.) of the different D2D links 108(1)-108(3) on communication channel 110 from direct 102(1) and (ii) begin to support communications from and/or to those indirect UEs via communication channel 110.

The types of communications supported by the cellular network 104 will depend on the number and characteristics of the D2D links 108, where the weakest link will determine the types of communications that are enabled. Note that, if link 108(3) is weaker than links 108(1) and 108(2), it is possible that greater communications will be possible with indirect UEs 102(2) and 102(3) than with indirect UE 102(4).

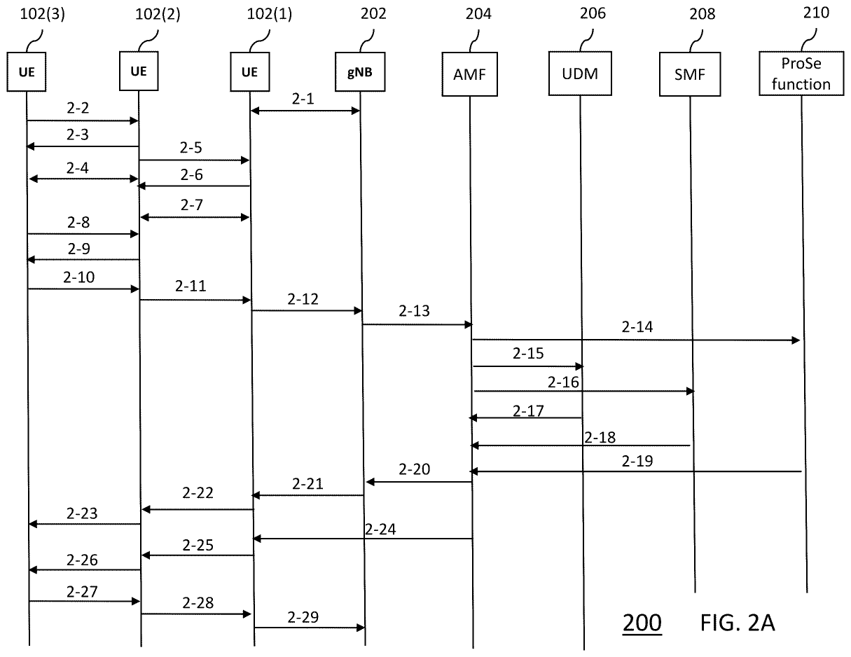

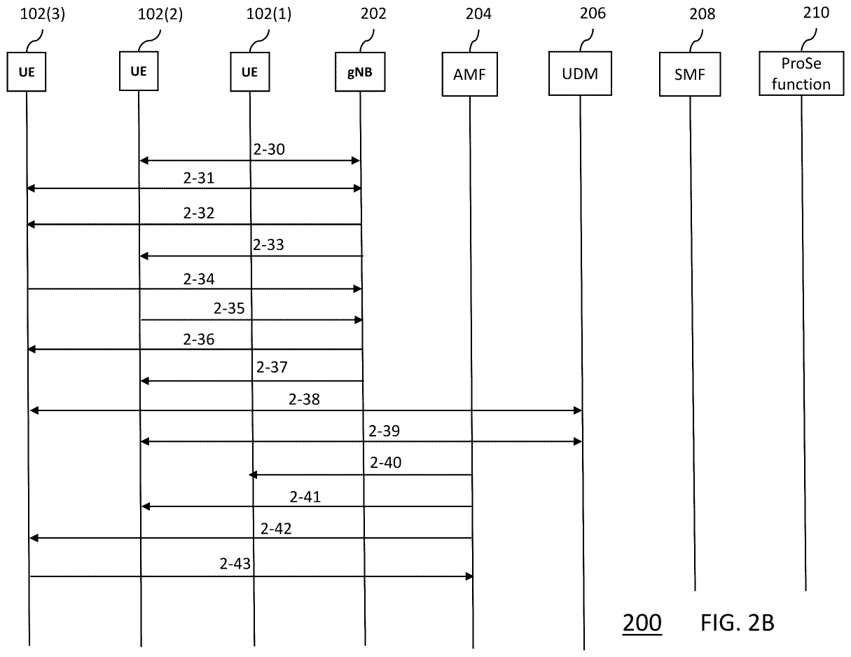

FIGS. 2A-2B represent the steps of an example process 200 of the present disclosure. Process 200 involves UEs 102(1)-102(3) of FIG. 1. Those skilled in the art will understand how to extend process 200 to include UE 102(4) of FIG. 1 as well as potentially additional UEs in situations involving more than three indirect UEs. In FIGS. 2A-2B, gnB 202 represents a base station of the cellular network 104 of FIG. 1, while Access and Mobility Management Function (AMF) 204, Unified Data Management (UDM) 206, Session Management Function (SMF) 208, and ProSe function 210 represent different functions performed by the core (i.e., the backend infrastructure) of the cellular network 104. The SMF function is responsible for tracking the sessions. The UDM function ensures that the UE belongs to the network and subsequently lets the AMF and SMF functions allow the UEs on the network. The Proximity Services (ProSe) function allows UEs to detect each other. The AMF function performs registration, authentication, tracking location and mobility, etc.

Note that some of the steps in process 200 may occur in sequences other than those depicted in FIGS. 2A-2B. For example, steps 2-5 to 2-7 may occur before or concurrently with steps 2-2 to 2-4. In other examples, step 2-31 may occur before or concurrently with step 2-30, step 2-33 may occur before or concurrently with step 2-32, step 2-35 may occur before or concurrently with step 2-34, step 2-37 may occur before or concurrently with step 2-36, step 2-39 may occur before or concurrently with step 2-38, and steps 2-40 to 2-42 may occur in any order or concurrently.

In step 2-1, UE 102(1) establishes cellular link 112 of FIG. 1 with gNB 202 using conventional cellular processing. The UE 102(1) has end-to-end connectivity with the core and the internet.

In step 2-2, indirect UE 102(3) broadcasts a D2D beacon message that is received by indirect UE 102(2). In response, in step 2-3, indirect UE 102(2) transmits a D2D beacon response to indirect UE 102(3) that enables D2D link 108(2) of FIG. 1 to be established in step 2-4.

Similarly, in step 2-5, indirect UE 102(2) broadcasts a D2D beacon message that is received by direct UE 102(1). In response, in step 2-6, direct UE 102(1) transmits a D2D beacon response to indirect UE 102(2) that enables D2D link 108(1) of FIG. 1 to be established in step 2-7. Note that, in step 2-6, direct UE 102(1) informs indirect UE 102(2) that UE 102(1) has a direct connection to the cellular network 104.

In step 2-8, UE 102(3) transmits a network connectivity query to UE 102(2) via D2D link 108(2) to ask if UE 102(2) has access to the cellular network 104. In response, in step 2-9, UE 102(2) transmits a network connectivity response to UE 102(3) via D2D link 108(2) to inform UE 102(3) that UE 102(2) does have network connectivity.

In step 2-10, UE 102(3) transmits a message to UE 102(2) via D2D link 108(2) to provide information about UE 102(3)'s capabilities and to inquire about UE 102(2)'s network connectivity. In step 2-11, UE 102(2) forwards UE 102(3)'s information along with its own information about UE 102(2)'s capabilities via D2D link 108(1) to UE 102(1). In step 2-12, UE 102(1) forwards UE 102(3)'s and UE 102(2)'s information along with its own information about UE 102(1)'s capabilities via cellular link 112 to gNB BA. In step 2-13, gNB BA forwards UE 102(3)'s, UE 102(2)'s, and UE 102(1)'s information to AMF 204 via the network backend infrastructure.

In step 2-14, AMF 204 forwards the information about the capabilities of UEs 102(1)-102(3) to ProSe function 210, which uses that information to determine what resources to grant to the UEs in order to establish optimal communications via the D2D links 108. As understood by those skilled in the art, the ProSe function 210 is a standard-based network function defined in D2D for LTE. The ProSe function 210 allows devices to detect each other and communicate directly. The ProSe function helps UEs in identifying each other's proximity either by constantly announcing a UE's location or by using a request-and-receive method. The ProSe function 210 provides those resource determinations to AMF 204 in step 2-19. AMF 204 will finalize and send these determinations over to gNB 202 for allocation.

In step 2-15, AMF 204 transmits a query to UDM 206 to confirm that the UEs 102 correspond to users who have active subscriptions to the cellular network 104. In step 2-17, UDM 206 transmits a positive response (i.e., an ACK) to AMF 204 confirming that those active subscriptions exist.

In step 2-16, AMF 204 transmits a message to SMF 208 requesting the establishment of communication channel 110 of FIG. 1 for billing and session management. In step 2-18, SMF 208 transmits an ACK to AMF 204 confirming the establishment of that communication channel 110.

In step 2-20, AMF 204 allocates the resources for the communication channel 110 to gNB 202. In step 2-21, gNB 202 configures those resources locally and informs UE 102(1) via cellular link 112 which resources are assigned to UEs 102(1)-102(3). In step 2-22, UE 102(1) configures its assigned resources and informs UE 102(2) via D2D link 108(1) which resources are assigned to UEs 102(2) and 102(3). In step 2-23, UE 102(2) configures its assigned resources and informs UE 102(3) via D2D link 108(2) which resources are assigned to UE 102(3) and UE 102(3) configures its assigned resources. If there are more UEs 102 in the chain 106, the UE 102(3) will continue the process.

In step 2-24, AMF 204 transmits a request for link information with a dynamic, decrementing counter via gNB 202 and cellular link 112 to UE 102(1), where the initial counter value corresponds to the number of UEs 102 in the chain 106 of links of FIG. 1. In response, UE 102(1) evaluates the cellular link 112.

In step 2-25, UE 102(1) decrements the counter value and forwards the request for link information via D2D line 108(1) to UE 102(2). In response, UE 102(2) evaluates the D2D

### Link 108(1).

In step 2-26, UE 102(2) decrements the counter value and forwards the request for link information via D2D line 108(2) to UE 102(3). In response, UE 102(3) evaluates the D2D link 108(2). Note that the counter value will continue to be decremented until the end of the chain 106 is reached, at which point the counter value will be at its minimum value (e.g., 0) and the last UE 102 in the chain 106 will know how to respond.

In step 2-27, UE 102(3) transmits its device capabilities and link quality and those for any other UEs that are downstream of UE 102(3) via D2D link 108(2) to UE 102(2). In step 2-28, UE 102(2) transmits its device capabilities and link quality and those for any other UEs that are downstream of UE 102(2) via D2D link 108(1) to UE 102(1). In step 2-29, UE 102(1) transmits its device capabilities and link quality and those for any other UEs that are downstream of UE 102(1) via cellular link 112 to gNB 202.

In steps 2-30 and 2-31, gNB 202 evaluates the device capabilities and link qualities of the various UEs 102 and establishes end-to-end communication channel 110 of FIG. 1 for UE 102(2), UE 102(3), and another other downstream UEs 102 in the chain 106 of links.

In steps 2-32 and 2-33, AMF 204 informs UE 102(3) and UE 102(2) of the communication services that are available from the cellular network 104 via the chain 106. In steps 2-34 and 2-35, UE 102(3) and UE 102(2) transmits requests for specific ones of the available communication services to AMF 204. In steps 2-36 and 2-37, AMF 204 allocates some or all of the requested communication services to UE 102(3) and UE 102(2). And in steps 2-38 and 2-39, UE 102(3) and UE 102(2) exchange data with UDM 206 within the allocated communication services.

In the particular scenario of FIGS. 2A and 2B, in steps 2-40 to 2-42, after AMF 204 determines that one or more of the D2D links 108 in the chain 106 are approaching their capacities, AMF 204 instructs UE 102(1)-102(3) to prioritize their data packets based on the importance of the related service and to buffer lower-priority data to avoid overloading the D2D links 108.

In the particular scenario of FIGS. 2A and 2B, in step 2-43, UE 102(3) transmits a request for a new data service to AMF 204. Although not shown in the figures, in response, AMF 204 will determine whether to grant the request and whether that newly granted data service will impact the other existing data services in the communication channel 110 and then communicate with the UEs 102 as needed about the new data service and any changes to the existing data services.

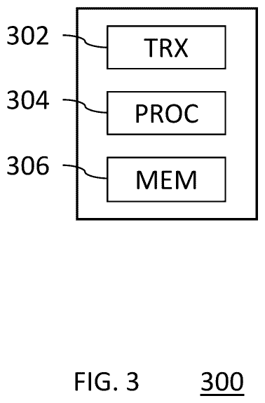

FIG. 3 is a simplified hardware block diagram of an example node 300 that can be used to implement any of the nodes XX of FIGs. XX, including the cellular network 104. As shown in FIG. 3, the node 300 includes (i) communication hardware (e.g., wireless, wireline, and/or optical transceivers (TRX)) 302 that supports communications with other nodes, (ii) one or more processors (e.g., CPU and/or GPU microprocessors) 304 that control the operations of the node 300 and/or process data within the node 300, and (iii) one or more memories (e.g., RAM, ROM) 306 that store code executed by the processors 304 and/or data generated and/or received by the node 300.

Although the present disclosure has been described in the context of UEs associated with vehicles, those skilled in the art will understand that the present disclosure can be implemented in the context of any suitable situation in which at least one UE has a direct cellular connection with a wireless network and one or more UEs that do not have such direct cellular connections, do have direct and indirect D2D capabilities between themselves and with the directly connected UE.

In certain embodiments, the present disclosure is a node for a chain comprising (i) a direct connection between direct user equipment (UE) and a cellular network and (ii) one or more device-to-device (D2D) connections, each D2D connection involving at least one indirect UE that does not have a direct connection with the cellular network. The node comprises a memory and at least one processor coupled to the memory and operative to support communications between the cellular network at each UE in the chain.

In at least some of the above embodiments, the node is the cellular network, and the cellular network is configured to control characteristics of the communications with each UE in the chain.

In at least some of the above embodiments, the cellular network is configured to handle situations in which a UE leaves the chain in order to continue to support communications with the chain's other UEs.

In at least some of the above embodiments, the node is the direct UE configured to have the direct connection with the cellular network, and the direct UE is configured to have a D2D connection with an indirect UE in the chain.

In at least some of the above embodiments, the node is an indirect UE in the chain configured to have a D2D connection with at least one other UE in the chain.

In at least some of the above embodiments, the indirect UE is configured to broadcast D2D beacon messages to establish the D2D connection with at least one other UE in the chain.

In at least some of the above embodiments, the chain comprises one or more other UEs downstream of the indirect UE, and the indirect UE is configured to support communications between the cellular network and the other UEs.

In at least some of the above embodiments, the chain comprises two or more D2D connections.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A node for a chain comprising (i) a direct connection between direct user equipment (UE) and a cellular network and (ii) one or more device-to-device (D2D) connections, each D2D connection involving at least one indirect UE that does not have a direct connection with the cellular network, the node comprising:
a memory; and
at least one processor, coupled to the memory and operative to support communications between the cellular network at each UE in the chain.

2. The node of claim 1, wherein:
the node is the cellular network; and
the cellular network is configured to control characteristics of the communications with each UE in the chain.

3. The node of claim 1, wherein the cellular network is configured to handle situations in which a UE leaves the chain in order to continue to support communications with the chain's other UEs.

4. The node of claim 1, wherein:
the node is the direct UE configured to have the direct connection with the cellular network; and
the direct UE is configured to have a D2D connection with an indirect UE in the chain.

5. The node of claim 1, wherein the node is an indirect UE in the chain configured to have a D2D connection with at least one other UE in the chain.

6. The node of claim 5, wherein the indirect UE is configured to broadcast D2D beacon messages to establish the D2D connection with at least one other UE in the chain.

7. The node of claim 5, wherein:
the chain comprises one or more other UEs downstream of the indirect UE; and
the indirect UE is configured to support communications between the cellular network and the other UEs.

8. The node of claim 1, wherein the chain comprises two or more D2D connections.

9. A method for a node in a chain comprising (i) a direct connection between a direct UE and a cellular network and (ii) one or more D2D connections, each D2D connection involving at least one indirect UE that does not have a direct connection with the cellular network, the method comprising supporting communications between the cellular network at each UE in the chain.

10. The method of claim 9, wherein:
the node is the cellular network; and
the cellular network controls characteristics of the communications with each UE in the chain.

11. The method of claim 9, wherein the cellular network handles situations in which a UE leaves the chain in order to continue to support communications with the chain's other UEs.

12. The method of claim 9, wherein:
the node is the direct UE having the direct connection with the cellular network; and
the direct UE has a D2D connection with an indirect UE in the chain.

13. The method of claim 9, wherein the node is an indirect UE in the chain having a D2D connection with at least one other UE in the chain.

14. The method of claim 13, wherein the indirect UE broadcasts D2D beacon messages to establish the D2D connection with at least one other UE in the chain.

15. The method of claim 13, wherein:
the chain comprises one or more other UEs downstream of the indirect UE; and
the indirect UE supports communications between the cellular network and the other UEs.

16. The method of claim 9, wherein the chain comprises two or more D2D connections.
